(19) United States
(12) Patent Application Publication
(10) Pub. No.: US 2025/0016855 A1
(43) Pub. Date: Jan. 9, 2025

(54) DATA TRANSFER METHOD OF HIERARCHICAL 6LOWPAN MESH NETWORK

(71) Applicant: Hangzhou Lianxintong Semiconductor Co.,Ltd., Hangzhou City (CN)

(72) Inventor: Chien-Tse YU, Zhubei City (TW)

(21) Appl. No.: 18/709,993

(22) PCT Filed: Dec. 1, 2021
(86) PCT No.: PCT/CN2021/134770

§ 371 Date: May 14, 2024

(30) Foreign Application Priority Data
Nov. 15, 2021 (CN) 202111369436.4

(51) Int. Cl. H04W 76/12; H04L 45/00; H04W 84/18

(52) U.S. Cl. CPC H04W 76/12; H04L 45/34; H04W 84/18

(57) ABSTRACT

The invention provides a data transfer method of a hierarchical 6LoWPAN mesh network. The hierarchical 6LoWPAN mesh network includes an application server and a NGW storing a routing table and a tunnel table, and has a level 1 mesh network and a level 2 mesh network. The method includes: a data transmitting step, in which a packet of the level 2 mesh network is transmitted on a 6LoWPAN leaf node of the level 1 mesh network through a tunnel between L1_6LN and NGW, wherein the tunnel is used to perform uplink transfer or downlink transfer between the L1_6LN and the NGW.

### FIELD OF THE INVENTION

The invention relates to a data transfer method of a hierarchical IPv6 over low power wireless personal area network (6LoWPAN) mesh network, and more particularly to a data transfer method through an IPv6-in-IPv6 tunnel, which uses a hierarchical 6LoWPAN network between a 6LoWPAN leaf node (level 1 6LoWPAN leaf node, hereinbelow referred to as L1_6LN) of a level 1 mesh network and a network gateway (hereinbelow referred to as NGW).

### DESCRIPTION OF RELATED ART

In the prior art, no matter which routing protocol is used in the 6LoWPAN mesh network, the 6LoWPAN border router (hereinbelow referred to as 6LBR) may function as a predetermined gateway for providing the 6LoWPAN leaf node (hereinbelow referred to as 6LN) with the connection to the external IP. The 6LBR is also in charge of managing IPv6 network positions of the 6LoWPAN mesh network, and may also be regarded as an autonomous routing area.

Because each 6LoWPAN works independently, the user frequently encounters a problem regarding “how to connect one 6LoWPAN to another 6LoWPAN to generate an IP connection.”

### SUMMARY OF THE INVENTION

The invention provides a data transfer method of a hierarchical 6LoWPAN mesh network, which uses a standard IPv6-in-IPv6 tunnel technology and an IPv6 address allocation to enhance the ability of NGW connecting to the hierarchical 6LoWPAN mesh network; may be applied to the high-tech intelligent Internet of things, such as level 1 broadband power line mesh network communication and level 2 low power wireless mesh network transmission; decreases the maintenance cost of the network of 6LBR and increases the network cover range; and can rapidly replace the existing network.

The invention provides a data transfer method of a hierarchical 6LoWPAN mesh network. The hierarchical 6LoWPAN mesh network includes an application server and a NGW storing a routing table and a tunnel table, and has a level 1 mesh network and a level 2 mesh network. The method includes a data transmitting step, in which a packet of the level 2 mesh network is transmitted on a 6LoWPAN leaf node (hereinbelow referred to as L1_6LN) of the level 1 mesh network through a tunnel between L1_6LN and NGW; wherein the tunnel is used to perform uplink transfer or downlink transfer between the L1_6LN and the NGW.

In an embodiment of the invention, the data transmitting step includes: a unicast data uplink transfer step, in which the packet of the level 2 mesh network may be transferred through the tunnel between L1_6LN and NGW, and the packet of the level 2 mesh network is transmitted to NGW from L1_6LN through the tunnel, or the packet of the level 2 mesh network is transmitted to NGW using predetermined routing without through the tunnel; and a unicast data downlink transfer step, in which the packet transferred by the NGW must be transmitted to L1_6LN using the tunnel.

In an embodiment of the invention, the data transmitting step includes: a multicast data uplink transfer step, in which the packet of the level 2 mesh network is transmitted to NGW through L1_6LN using the tunnel between L1_6LN and NGW; and a multicast data downlink transfer step, in which NGW transfers the packet through the tunnel between L1_6LN and NGW, and the packet is transmitted to L1_6LN from NGW through the tunnel, and then L1_6LN broadcasts the packet into the level 2 mesh network; or NGW transfers the packet directly broadcasted into the level 1 mesh network and then L1_6LN forwards the packet into the level 2 network without through the tunnel.

### BRIEF DESCRIPTION OF DRAWINGS

In order to illustrate the technical solutions in the embodiments of the invention more clearly, the necessary drawings to be used in the description of the embodiments will be briefly introduced below. Obviously, the drawings in the following description only refer to some embodiments of the invention. For those of ordinary skill in the art, other drawings can also be obtained based on these drawings without exerting creative efforts.

FIG. 1 shows IPv6 addressing and data transfer processes of a hierarchical 6LoWPAN mesh network of the invention.

FIG. 2 shows a routing table and a tunnel table of a downlink tunnel.

FIG. 3 shows a unicast data transfer process of the hierarchical 6LoWPAN mesh network of the invention.

FIG. 4 shows a multicast data transfer process of the hierarchical 6LoWPAN mesh network of the invention.

### DETAILED DESCRIPTION OF THE INVENTION

In order to make the purpose, technical solutions and advantages of the embodiments of the invention clearer, the embodiments of the invention will be further described in detail below with reference to the accompanying drawings. Herein, the illustrative embodiments of the invention and their descriptions are used to explain the invention without limiting the invention.

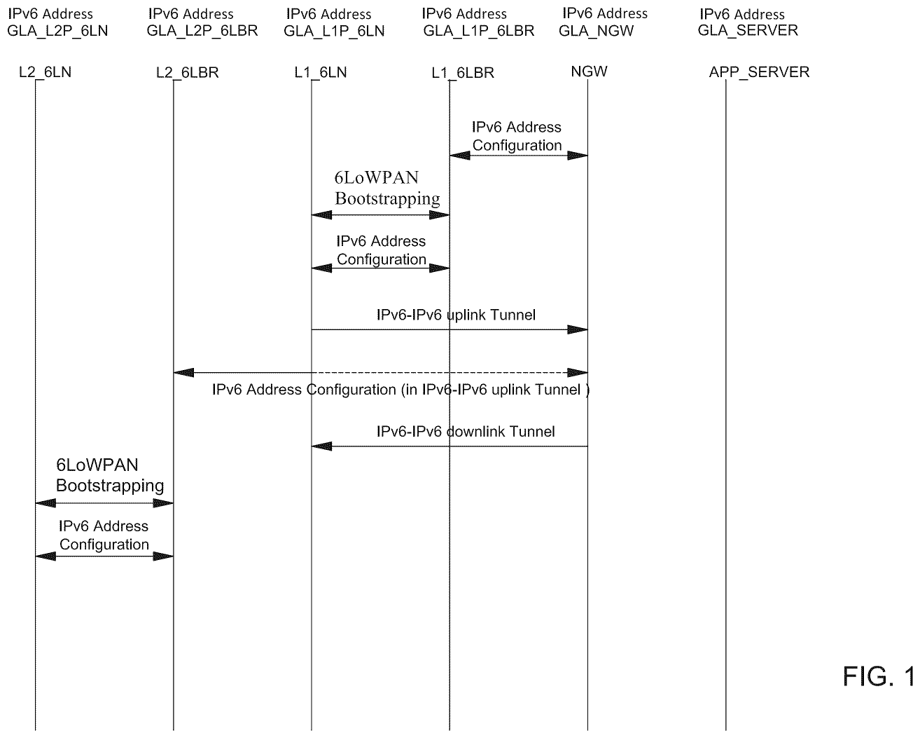

FIG. 1 shows IPv6 addressing and data transfer processes of a hierarchical 6LoWPAN mesh network of the invention. Referring to FIG. 1, the hierarchical 6LoWPAN mesh network includes an application server (hereinbelow referred to as APP_SERVER), a NGW, a level 1 mesh network L1, and a level 2 mesh network L2. The level 1 mesh network L1 includes a L1_6LN and a 6LoWPAN border router of the level 1 mesh network L1 (hereinbelow referred to as L1_6LBR); and the level 2 mesh network L2 includes a 6LoWPAN leaf node of the level 2 mesh network L2 (hereinbelow referred to as L2_6LN) and a 6LoWPAN border router of the level 2 mesh network L2 (hereinbelow referred to as L2_6LBR).

For conciseness, IPV6 addresses of APP_SERVER, NGW, L1_6LBR, L1_6LN, L2_6LBR, and L2_6LN are respectively defined as GLA_SERVER, GLA_NGW, GLA_L1P_6LBR, GLA_L1P_6 LN, GLA_L2P_6LBR and GLA_L2P_6LN in this embodiment.

L1P and L2P in GLA_L1P_6LBR, GLA_L1P_6 LN, L2P_6LBR, and L2P_6LN represent IPv6 address prefixes. L1P and L2P respectively represent segments or address ranges of the level 1 mesh network L1 and the level 2 mesh network L2. The IPV6 address GLA_SERVER of APP_SERVER represents a global address connecting to the Internet. That is, the data of APP_SERVER can be routed to the Internet.

In an embodiment of the invention, NGW is in charge of managing IPv6 address prefixes in the 6LoWPAN network, an IPv6 network position of each 6LoWPAN must be a subset of an IPv6 network position of NGW, and the level 1 mesh network L1 and the level 2 mesh network L2 are parallel subnets in this embodiment. So, the address prefixes of the level 1 mesh network L1 and the level 2 mesh network L2 have a same length.

First, L1_6LBR sends a router solicitation packet to NGW, and NGW performs IPv6 address configuration on L1_6LBR, so that L1_6LBR obtains the IPv6 address of GLA_L1P_6LBR. At this time, L1_6LBR performs 6LoWPAN bootstrapping at this node to add the level 1 mesh network L1 and become L1_6LN. Next, L1_6LN sends an address configuration request packet to L1_6LBR, and L1_6LBR performs the IPv6 address configuration to make L1_6LN obtain the address prefix having the length the same as that of L1_6LBR. So, L1_6LN obtains the IPv6 address of GLA_L1P_6LN.

In an embodiment of the invention, the router solicitation packet may be SLAAC, which is implemented by an IPv6 StateLess Address AutoConfiguration packet or a dynamic host configuration protocol for IPv6 (DHCPv6) packet, and L1_6LBR performs transfer routing to broadcast the packet through multicasting. An IPv6-IPv6 uplink tunnel is present between L1_6LN and NGW, wherein the uplink tunnel represents the tunnel in a transfer direction from L1_6LN to NGW. In one embodiment, the IPv6-IPv6 tunnel is established when L1_6LN receives the position configuration request broadcast packet of L2_6LBR. At this time, the uplink tunnel between L1_6LN and NGW is established.

The NGW routing table records an address prefix and an interface of a destination address of the level 1 mesh network L1 and the level 2 mesh network L2. The interface of the level 1 mesh network L1 is a physical interface or a virtual interface, and the interface of the level 2 mesh network L2 is TUN_L2_6BR. The routing table records references of packet downlink transmission interfaces of the level 1 mesh network L1 and the level 2 mesh network L2.

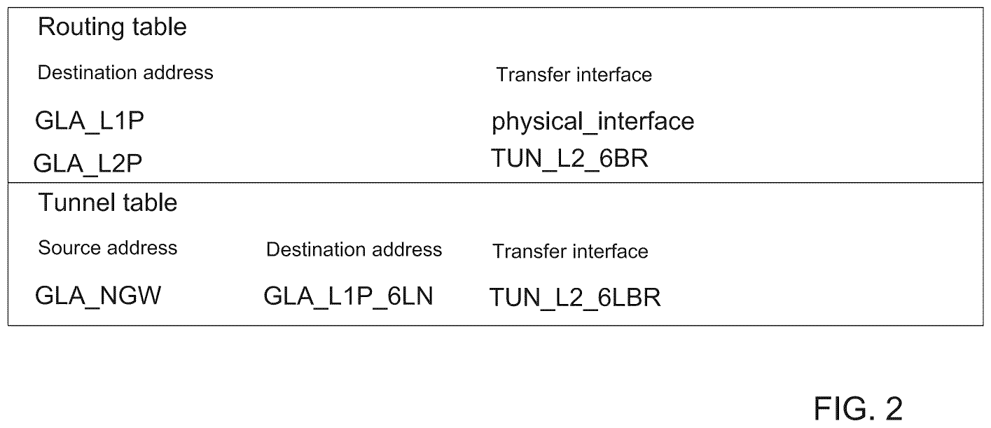

In this embodiment, in the routing table, the interface of the level 1 mesh network L1 being a physical layer interface physical_interface representing a physical layer functioning as the transfer interface is used, and the interface of the level 2 mesh network L2 being a tunnel interface TUN_L2_6BR representing that a GLA_L2P segment uses the tunnel to function as the transfer interface, as shown in FIG. 2.

Because the level 1 mesh network L1 and the level 2 mesh network L2 are parallel subnets, and an IPv6-IPv6 uplink tunnel is present between L1_6LN and NGW, L2_6LBR multicasts and sends an address request packet to NGW, and the packet can be forwarded to NGW (indicated by the dashed line) through L1_6LN via the IPv6-IPv6 uplink tunnel, so that NGW performs the IPV6 address configuration on L2_6LBR, and that L2_6LBR obtains the IPv6 address of GLA_L2P_6LBR. In other words, L2_6LBR transfers the address request packet to L1_6LN by way of multicasting, and L1_6LN unicasts and forwards the packet to NGW through the IPv6-IPv6 uplink tunnel.

After the NGW receives the address request packet of L2_6LBR in the uplink tunnel, NGW can establish the IPv6-IPv6 downlink tunnel from NGW to L1_6LN, and the downlink tunnel represents the tunnel in the transfer direction from NGW to L1_6LN.

The tunnel table of NGW records the downlink tunnel as the source address being the address of NGW and the destination address as the address of L1_6LN, and the tunnel interface of TUN_L2_6BR represents that an outer IPv6 header needs to be packaged when the TUN_L2_6BR is used to function as the transmission interface, wherein the source position is GLA_NGW and the destination address is GLA_L1P_6LN, as shown in FIG. 2.

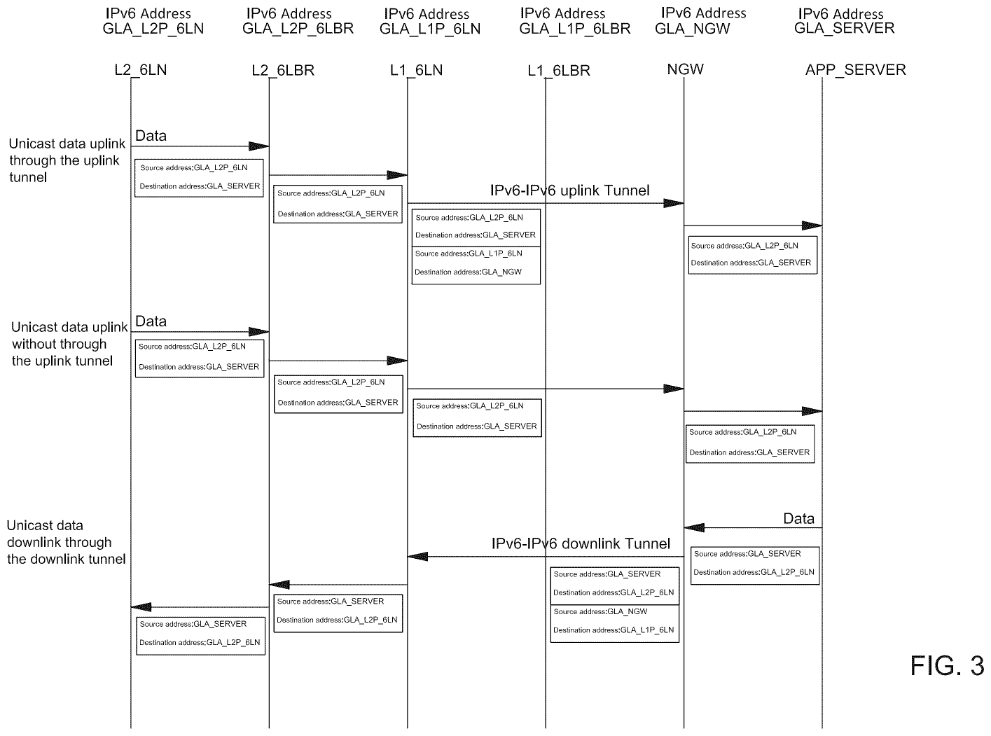

At this time, L2_6LBR performs 6LoWPAN bootstrapping at this node to add the level 2 mesh network L2 and become L2_6LN, and then L2_6LN sends the address request packet to L2_6LBR. The L2_6LBR performs the IPV6 address configuration to make L2_6LN obtain the address prefix having the length the same as that of L2_6LBR, so L2_6LN obtains the IPV6 address of GLA_L2P_6LN. FIG. 3 shows a unicast data transfer process of the hierarchical 6LoWPAN mesh network of the invention. Referring next to FIG. 3, in the unicast data uplink transfer step, a packet of the level 2 mesh network L2 may be transferred from the uplink tunnel between L1_6LN 5 and NGW through the uplink tunnel, and the packet of the level 2 mesh network L2 is transmitted from L1_6LN to NGW through the uplink tunnel. That is, the header of the packet of the level 2 mesh network is added, by L1_6LN, with the source address and a destination address corresponding to the uplink tunnel, the source address is the address of L1_6LN, and the destination address is the address of the NGW, thereby functioning as the uplink tunnel from L1_6LN to NGW.

So, when the data Data is transferred from L2_6LN, its initial source address at the header of L2_6LN is GLA_L2P_6LN, and the destination address is GLA_SERVER. However, when the data is forwarded at L1_6LN through the uplink tunnel, L1_6LN adds the second layer header, the source address of the second layer header is GLA_L1P_6LN, and the destination address is GLA_NGW, thereby functioning as the identification of the uplink tunnel from L1_6LN to NGW.

Correspondingly, when the packet of the level 2 mesh network L2 is transmitted to NGW using predetermined routing without through the uplink tunnel, the initial source address at the header of L2_6LN is GLA_L2P_6LN, the destination address is GLA_SERVER, and the packet is transmitted to APP_SERVER according to the predetermined routing.

In the unicast data downlink transfer step, the packet transferred from NGW to the level 2 mesh network L2 needs to be transmitted to L1_6LN using the downlink tunnel, NGW adds the header of the packet of the level 1 mesh network L1 with the source address and the destination address corresponding to the downlink tunnel, the source address is the address of NGW, and the destination address is the address of L1_6LN, thereby functioning as the downlink tunnel from NGW to L1_6LN.

So, when APP_SERVER transfers the data Data, its initial source address at the header of APP_SERVER is GLA_SERVER, and the destination address is GLA_L2P_6LN. However, when NGW forwards the data through the downlink tunnel, NGW adds the second layer header, the source address of the second layer header is GLA_SERVER, and the destination address is GLA_L1P_6LN, thereby functioning as the identification of the downlink tunnel from NGW to L1_6LN.

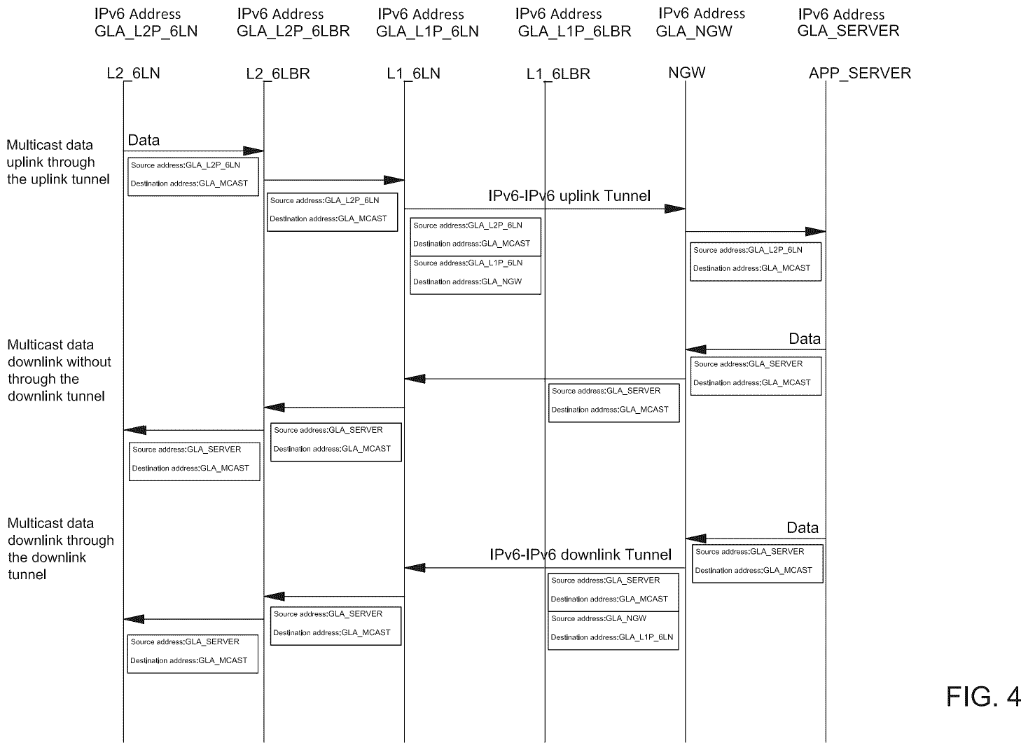

Please refer next to FIG. 4. FIG. 4 shows a multicast data transfer process of the hierarchical 6LoWPAN mesh network of the invention.

The data transmitting step includes a multicast data uplink transfer step, in which the packet of the level 2 mesh network L2 is transmitted to NGW using the uplink tunnel between L1_6LN and NGW through L1_6LN.

In the multicast data uplink transfer step, when the packet of the level 2 mesh network L2 is transferred through the uplink tunnel, L1_6LN adds the header of the packet of the level 2 mesh network L2 with a source address and a destination address corresponding to the uplink tunnel, wherein the source address is the address of L1_6LN, and the destination address is the address of NGW, thereby functioning as the uplink tunnel from L1_6LN to NGW.

When the data Data is transferred from L2_6LN, its initial source address of the header of L2_6LN is GLA_L2P_6LN, and the destination address is GLA_MCAST representing multicasting to APP_SERVER. However, when L1_6LN forwards the data through the uplink tunnel, L1_6LN adds the second layer header, wherein the source address of the second layer header is GLA_L1P_6LN, and the destination address is GLA_NGW, thereby functioning as identification of the uplink tunnel from L1_6LN to NGW. The data Data is finally transmitted to APP_SERVER.

Please note that in the multicast data downlink transfer step, NGW transfers the packet through the downlink tunnel between L1_6LN and NGW, and the packet is transmitted from NGW to L1_6LN through the downlink tunnel, and then L1_6LN broadcasts the packet into the level 2 mesh network L2; or NGW directly broadcasts the data Data into the level 1 mesh network L1 without through the downlink tunnel.

When NGW directly broadcasts the data into the level 1 mesh network L1 without through the downlink tunnel, its initial source address at the header of APP_SERVER is GLA_SERVER, and the destination address is GLA_MCAST. Because the broadcast is performed in the level 1 mesh network L1 without through the downlink tunnel, NGW does not add the second layer header, and the data is finally transmitted to L2_6LN of the level 2 mesh network L2.

When the packet of the level 1 mesh network L1 is transferred through the downlink tunnel, NGW adds the header of the packet of the level 1 mesh network L1 with the source address and the destination address corresponding to the downlink tunnel, the source address is the address of NGW, and the destination address is the address of L1_6LN, thereby functioning as the downlink tunnel from NGW to L1_6LN.

Therefore, when APP_SERVER transfers the data Data, its initial source address at the header of APP_SERVER is GLA_SERVER, and the destination address is GLA_MCAST. However, when NGW forwards the data through the downlink tunnel, NGW adds the second layer header, the source address of the second layer header is GLA_SERVER, and the destination address is GLA_L1P_6LN, thereby functioning as identification of the downlink tunnel from NGW to L1_6LN. The data is finally transmitted to L2_6LN of the level 2 mesh network L2.

In summary, the invention provides the data transfer method of the hierarchical 6LoWPAN mesh network, which uses the standard IPv6-in-IPv6 tunnel technology and the IPv6 address allocation to enhance the ability of NGW connecting to the hierarchical 6LoWPAN mesh network. Even though two different routing protocols “mesh-under” and “route-over” are used in the 6LoWPAN mesh network, the tunnel can be established in the network layer.

1. A data transfer method of a hierarchical 6LoWPAN mesh network, the hierarchical 6LoWPAN mesh network comprising a network gateway NGW storing a routing table and a tunnel table, and having a level 1 mesh network and a level 2 mesh network, the method comprising:
a data transmitting step, in which a packet of the level 2 mesh network is transmitted on a 6LoWPAN leaf node of the level 1 mesh network through a tunnel between a L1_6LN and the NGW,
wherein the tunnel is used to perform uplink transfer or downlink transfer between the L1_6LN and the NGW.

2. The data transfer method of the hierarchical 6LoWPAN mesh network according to claim 1, wherein the data transmitting step comprises:
a unicast data uplink transfer step, in which the packet of the level 2 mesh network may be transferred through the tunnel, and the packet of the level 2 mesh network is transmitted from the L1_6LN to the NGW through the tunnel, or the packet of the level 2 mesh network is transmitted to the NGW using predetermined routing without through the tunnel; and
a unicast data downlink transfer step, in which a packet transferred by the NGW needs to be transmitted to the L1_6LN using the tunnel.

3. The data transfer method of the hierarchical 6LoWPAN mesh network according to claim 2, wherein in the unicast data uplink transfer step, when the packet of the level 2 mesh network is transferred through the tunnel, a header of the packet of the level 2 mesh network is generated by the L1_6LN added with a source address and a destination address corresponding to the tunnel, the source address is an address of the L1_6LN, and the destination address is an address of the NGW, thereby functioning as an uplink tunnel from the L1_6LN to the NGW.

4. The data transfer method of the hierarchical 6LoWPAN mesh network according to claim 2, wherein in the unicast data downlink transfer step, when the packet of the level 1 mesh network is transferred through the tunnel, a header of the packet of the level 1 mesh network is generated by the NGW added with a source address and a destination address corresponding to the tunnel, the source address is an address of the NGW, and the destination address is an address of the L1_6LN, thereby functioning as a downlink tunnel from the NGW to the L1_6LN.

5. The data transfer method of the hierarchical 6LoWPAN mesh network according to claim 1, wherein the data transmitting step comprises:
a multicast data uplink transfer step, in which the packet of the level 2 mesh network is transmitted to the NGW through the L1_6LN using the tunnel between the L1_6LN and the NGW; and
a multicast data downlink transfer step, in which the NGW transfers a packet through the tunnel between the L1_6LN and the NGW, and the packet is transmitted from the NGW to the L1_6LN through the tunnel, and then the L1_6LN broadcasts the packet into the level 2 mesh network; or the NGW transfers the packet directly broadcasted into the level 1 mesh network without through the tunnel.

6. The data transfer method of the hierarchical 6LoWPAN mesh network according to claim 5, wherein in the multicast data uplink transfer step, when the packet of the level 2 mesh network is transferred through the tunnel, a header of the packet of the level 2 mesh network is generated by the L1_6LN added with a source address and a destination address corresponding to the tunnel, the source address is an address of the L1_6LN, and the destination address is an address of the NGW, thereby functioning as an uplink tunnel from the L1_6LN to the NGW.

7. The data transfer method of the hierarchical 6LoWPAN mesh network according to claim 6, wherein in the multicast data downlink transfer step, when the packet of the level 2 mesh network is transferred through the tunnel, a header of the packet of the level 1 mesh network is generated by the NGW added with the source address and the destination address corresponding to the tunnel, the source address is the address of the NGW, the destination address is the address of the L1_6LN, thereby functioning as a downlink tunnel from the NGW to the L1_6LN.

8. The data transfer method of the hierarchical 6LoWPAN mesh network according to claim 1, wherein a 6LoWPAN border router L2_6BR in the level 2 mesh network establishes the tunnel for uplink from the L1_6N to the NGW according to an address request packet.

9. The data transfer method of the hierarchical 6LoWPAN mesh network according to claim 8, wherein when the NGW receives the address request packet for uplink from the L2_6BR to the tunnel, the NGW establishes the tunnel for downlink from the NGW to the L1_6LN.

10. The data transfer method of the hierarchical 6LoWPAN mesh network according to claim 9, wherein the routing table records an address prefix and an interface of a destination address of the level 1 mesh network and the level 2 mesh network; wherein the interface of the level 1 mesh network is a physical interface or a virtual interface, the interface of the level 2 mesh network is the TUN_L2_6BR, and the routing table records a segment of the tunnel through which the packet of the level 2 mesh network passes.

11. The data transfer method of the hierarchical 6LoWPAN mesh network according to claim 10, wherein the tunnel table of the NGW records a downlink tunnel as the source address being an address of the NGW, the destination address being an address of the L1_6LN, and the interface of the tunnel being the TUN_L2_6BR.

12. The data transfer method of the hierarchical 6LoWPAN mesh network according to claim 10, wherein the address prefixes of the level 1 mesh network and the level 2 mesh network have a same length.
